(19) United States
(12) Patent Application Publication
(10) Pub. No.: US 2009/0214305 A1
(43) Pub. Date: Aug. 27, 2009

(54) COOLANT NOZZLES FOR MILLING CUTTERS

(76) Inventors: James M. Waggle, Derry, PA (US); Kevin M. Gamble, Stahlstown, PA (US)

Correspondence Address: KENNAMETAL INC.;Intellectual Property Department, P.O. BOX 231, 1600 TECHNOLOGY WAY, LATROBE, PA, 15650, US

(21) Appl. No.: 12/035,475

(22) Filed: Feb. 22, 2008

(51) Int. Cl. B26D 1/12; B23Q 1/00

(52) U.S. Cl. 407/48; 409/136

(57) ABSTRACT

A milling cutter 1 with a directed coolant delivery system is disclosed. The milling cutter 1 may have a plurality of coolant ducts 40 which span from a centrally located reservoir 42 or distribution point within the body 20 of the milling cutter 1 to a series of recesses 10 on the exterior of the body 20. Coolant nozzles 50 are inserted into a countersunk portion 51 between the coolant duct 40 and the recesses 10. The countersunk portions 51 provide protection for the coolant nozzles 50. Each coolant nozzle 50 has a bore 58 which may be narrower than the coolant duct 40 or alternatively may have a bore 58 and a restriction 60. Nozzles of the present invention provide consistent streams of coolant to the to the tool-workpiece interface to enable precise adjustment of the streams of a coolant from a position close to the tool-workpiece interface.

### FIELD OF THE INVENTION

The present invention relates to coolant nozzles for milling cutters for machining and metalworking, and in particular to coolant nozzles of a fluid cooling system for multi-pocket milling cutters.

### BACKGROUND INFORMATION

Cooling fluid, e.g., light cutting oil, is often used in metalworking operations. The cooling fluid is often delivered through a passage to a discharge point near an interface between a cutting tool and a work piece. The cooling fluid serves to prolong the life of the cutting tool or insert, and also enables faster cutting or machining of the work piece, by reducing friction and assisting in heat transfer from the work piece to the cutting tool at the interface between the two.

Many coolant delivery systems clamp an exterior tube onto the cutting tool holder to deliver cooling fluid to the cutting tool. These systems are inexpensive and easy to assemble but are often flimsy, easily damaged and incapable of discharging cooling fluid near the cutting tool-workpiece interface. Other cooling fluid delivery systems provide a duct through the tool holder which discharges in an area near the insert. However, correct sizing of the ducts presents manufacturing challenges. Drilling a long duct with a small drill bit is difficult. The small bit often breaks and causes significant downtime and cost. Small ducts also take a long time to make due to longer cycle times. As a result, larger bits are used to bore larger ducts, but coolant system pressure losses due to the larger ducts cause poor coolant delivery and ineffective cooling. The present invention has been developed in view of the foregoing.

### SUMMARY OF THE INVENTION

The present invention provides a milling cutter with a directed coolant delivery system. The milling cutter may have a plurality of coolant ducts which span from a centrally located reservoir or distribution point within the body of the milling cutter to a series of recesses within pockets on the exterior of the body. Coolant nozzles are inserted into a countersunk portion between the coolant duct and the recesses. The countersunk portions provide protection for the coolant nozzles. Each coolant nozzle has a bore narrower than the coolant duct or alternatively may have a bore and a restriction. Nozzles of the present invention provide a precise stream of coolant to the tool-workpiece interface from a position close to the tool-workpiece interface and in a manner that equally distributes coolant to all pockets.

An aspect of the present invention provides a milling cutter comprising a cutter body including a plurality of recessed cutting portions, a coolant reservoir within the cutter body, a plurality of coolant ducts extending from the reservoir to the recessed cutting portions each having a reservoir end and a discharge end and at least one coolant nozzle inserted into the discharge end of the coolant duct having a restriction having an internal diameter less than an internal diameter of the discharge end of the coolant duct.

Another aspect of the present invention provides a milling cutter comprising a cutter body including a plurality of recessed cutting portions a coolant reservoir within the cutter body, a plurality of coolant ducts extending from the reservoir to the recessed cutting portions each having a reservoir end, discharge end and a countersunk portion and a coolant nozzle having a head and a threaded portion.

Yet another aspect of the current invention provides a coolant nozzle for use in a milling cutter comprising an inlet end, a discharge end, a bore between inlet end and the discharge end and having an inside diameter and providing fluid communication between the inlet end and discharge end, a driver indentation in fluid communication with the inlet end and discharge end located between the discharge end and the bore having an inside diameter or width greater than the inside diameter of the bore structured and arranged to receive a driving device, wherein the bore and driver indentation are centered about a longitudinal axis of the nozzle.

### BRIEF DESCRIPTION OF THE DRAWINGS

Further features of the present invention, as well as the advantages derived therefrom, will become clear from the following detailed description made with reference to the drawings in which:

FIG. 1 is an oblique view of a milling cutter with replaceable inserts and coolant nozzles according to one embodiment of the present invention.

FIG. 2 is a section view of the milling cutter shown in FIG. 1 along section line 22 of FIG. 1 according to one embodiment of the present invention.

FIG. 3 is an enlarged oblique view of a recess in the body of a milling cutter for the cutting insert and coolant nozzle according to one embodiment of the present invention.

FIG. 4 is a side view of a coolant nozzle according to one embodiment of the present invention.

FIG. 5 is a front view of the head of a coolant nozzle according to one embodiment of the present invention.

FIG. 6 is a side cross-section of a coolant nozzle showing the bore and restriction according to one embodiment of the present invention.

FIG. 7 is a section view of a milling cutter along a coolant duct with a plug type of coolant nozzle according to one embodiment of the present invention.

### DETAILED DESCRIPTION

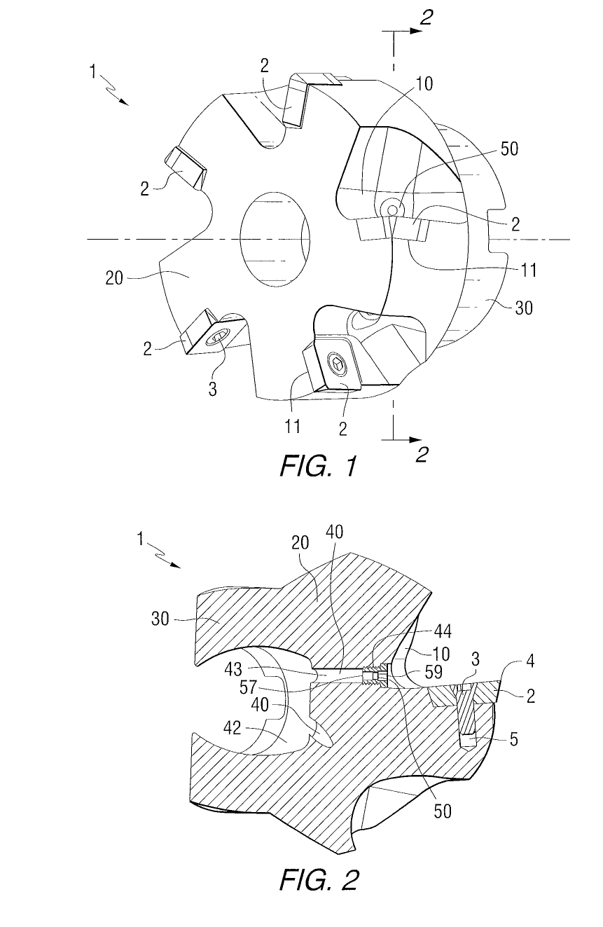

A milling cutter 1 with replaceable cutting inserts 2 is shown in FIG. 1 according to one embodiment of the present invention. The milling cutter 1 has a plurality of recesses 10 within the body 20 of the milling cutter 1. The recesses 10 provide clearance for installation of cutting inserts 2 which are the cutting portion of the milling cutter 1. The cutting inserts 2 are often indexable, replaceable inserts made in whole or in part from, for example, carbides, including tungsten carbide, titanium carbide and tantalum carbide, aluminum oxide, titanium nitride, cobalt, cubic boron nitride, including ceramics, and alloys and cermets of these materials. Recesses 10 include seating surfaces 11 for seating of the cutting inserts 2. The cutting inserts 2 are held against the seating surfaces 11 by way of retention screw 3 which is threadedly engaged with an aperture 5 within the seating surface 11 of the body 20. Projecting from the body 20 is the mounting member 30. The shank 30 is the portion of the milling cutter 1 which attaches to a rotating drive apparatus (not shown). The milling cutter and drive apparatus share a common axis of rotation illustrated by the dashed line in FIG. 1. The shank 30 also provides a path for delivering coolant to the milling cutter 1.

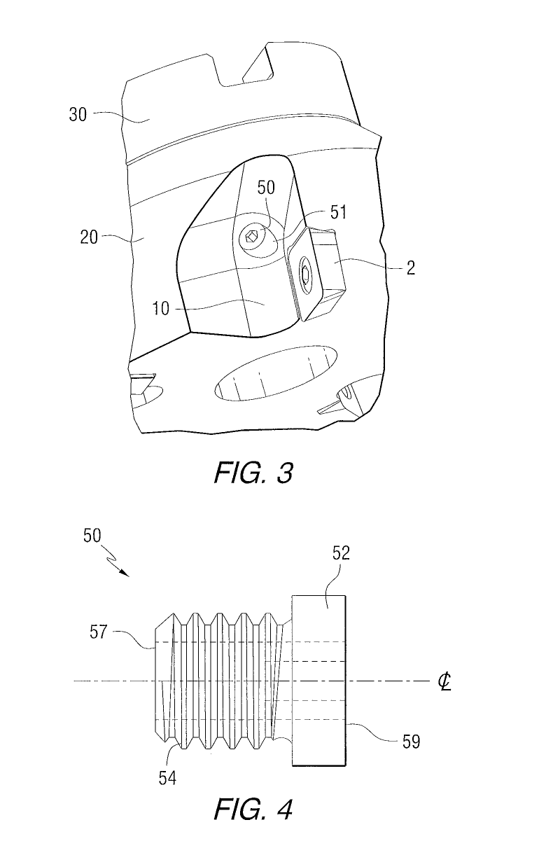

Referring now to FIG. 2, a sectional view of the milling cutter 1 of FIG. 1 is shown along section line 2-2. Section 2-2 is taken along a center line of a coolant duct 40 which provides passage of coolant from a centrally located reservoir 42 within the milling cutter 1 to the recess 10. At the recess 10 end of the duct 40 is a coolant nozzle 50 which provides a restriction at the recess 10 end of the coolant duct 40. The coolant nozzle 50 has an inlet end 57 for receiving coolant that is proximally positioned in coolant duct 40 and a discharge end 59 that is distally located near the recess 10. As seen in FIG. 2 the coolant duct 40 has a reservoir end 43 and a discharge end 44. The discharge end 44 may be fitted with internal threads for receiving an externally threaded coolant nozzle 50. The coolant nozzle 50 has a reduced diameter bore which restricts the relatively large diameter coolant duct 40 to ensure fluid pressure is not lost and coolant is propelled to the cutting edge 4 of the cutting insert 2. As seen in FIG. 3, a countersunk portion 51 transitions between the recess 10 and duct 40 to allow clearance for the head 50 of the nozzle 40. Countersunk portion 51 has an inside diameter greater than an inside diameter of the coolant duct 40 and at least as large as nozzle head 50. In this manner, the head 50 can be securely fastened against the countersunk portion 51. Additionally, countersunk portion 51 provides protection for the coolant nozzle 40 preventing it from plugging or being damaged, for example, by metal chips or other debris. As used herein, the term “countersunk portion” refers to a hole with the top part enlarged so that a screw or bolt will fit into it and lie below the surface. A countersunk portion would include by way of example cylindrical and non-cylindrical counter bores and countersinks.

Referring to FIGS. 2 and 3, it is to be noted that the bore 58 of the coolant nozzle 50 is aligned with and in close proximity to the cutting edge 4 of the insert 2. In the preferred embodiment, the bore 58 and restriction 60 are aligned with the corner of the insert cutting edge 4 as illustrated in FIGS. 1-3. Additionally, the coolant nozzle 50 is integrated into the coolant duct 40 and countersunk portion 51 of the body 10 of milling cutter 1. In this manner, a narrow stream of coolant can precisely be delivered to the interface of the tool and workpiece being cut.

FIG. 4 shows an isolated side view of a nozzle 50 according to one embodiment of the present invention. As shown, nozzle 50 has a threaded portion 54 that is inserted in duct 40 to hold the nozzle 50 in place. Threaded portion 54 has an outside diameter which corresponds to the inside diameter of the coolant duct 40 to enable threaded engagement of the two components. Coolant nozzle 50 may also have an expanded head portion 52 for the nozzle which seats in the countersunk portion 51 between the duct 40 and the recess 10. Nozzle 50 is configured about a central longitudinal axis shown as the centerline in FIG. 4.

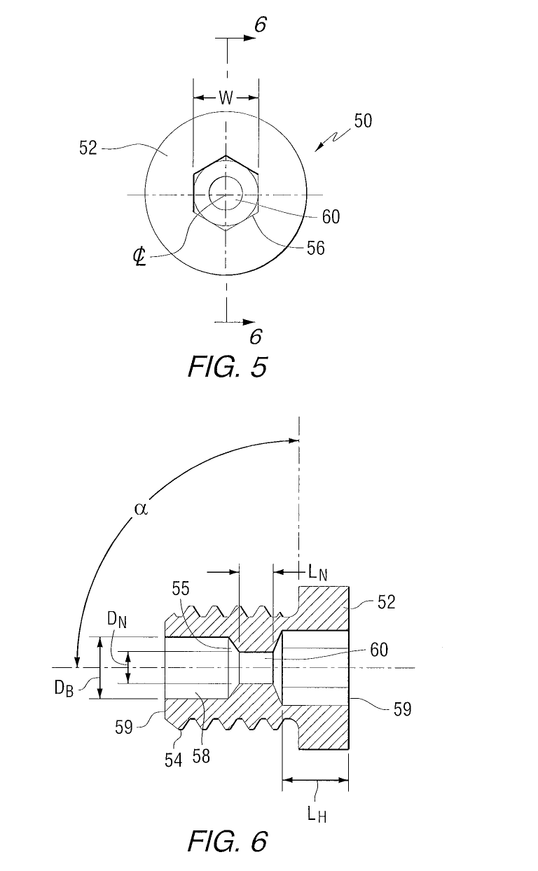

Referring now to FIG. 5, a front view of the nozzle's head 52 with a driver indentation 56 is shown according to one embodiment of the present invention. The driver indentation 56 is shown here as having an internally dimensioned, generally hexagonal shape but may be many different configurations, for instance, a star-shaped pattern, an X-shaped pattern, or square. In another embodiment of the present invention, the head may have a bolt head type of configuration whereby a socket is used to tighten and loosen the coolant nozzle within the coolant duct. The discharge end of restriction 60 can also be seen in this view. Driver portion 56 has a width shown as W in FIG. 5 which is greater than or equal to the restriction 60. W may be about 1 mm to about 3 mm, for example 2 mm. The driver indentation 56 is configured to provide removal and installation of nozzles 50 with standard tools and also provides protection for the discharge end of restriction 60 while not interfering with the streaming discharge of liquid coolant from the nozzle 50.

Referring now to FIG. 6, a cross section of the nozzle 50 shown in FIGS. 4 and 5 is illustrated. The cross section is taken along section lines 6-6 of FIG. 5. As can be seen in FIG. 6, the nozzle 50 has a bore 58 near inlet end 57 of the coolant nozzle 50. The bore 58 may have a diameter, D_{b}, less than the inside diameter of a coolant duct 40 for which it is sized. Positioned between the bore 58 and the driver indentation 56 is a restriction 60. The restriction 60 may have a diameter of about 0.5 mm to about 2.5 mm, for example 1.5 mm. In a preferred embodiment, the restriction 60 also has a length Lₙ, of no less than 1 mm. Restriction 60 and/or bore 58 is sized to enable a more consistent flow through ducts to the cutting edge of the cutting inserts and focus the coolant into a narrower stream. The width or diameter of the driver indentation should be dimensioned at least as wide as restriction so clearance is providing for the exiting coolant stream.

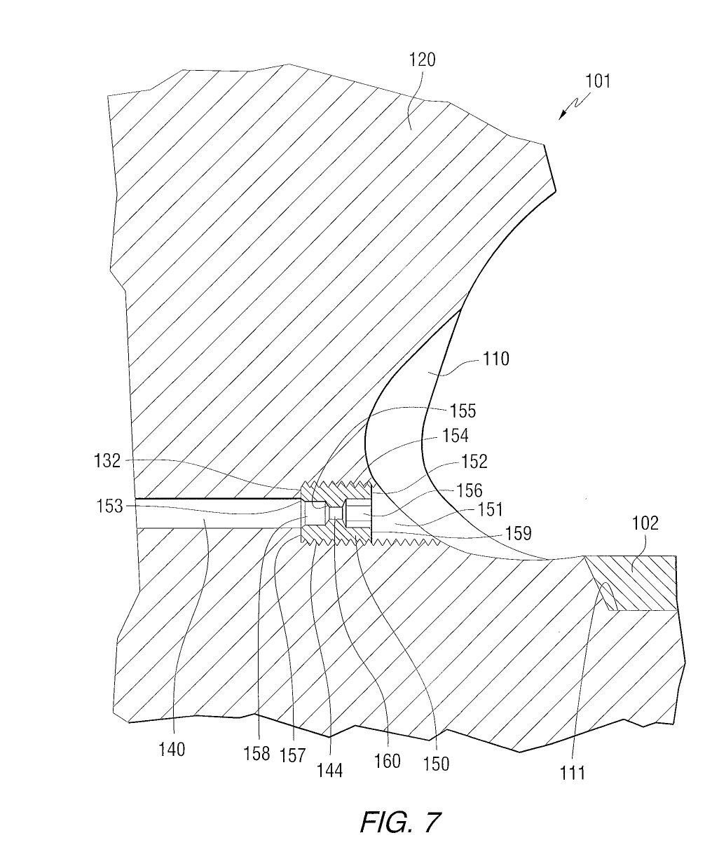

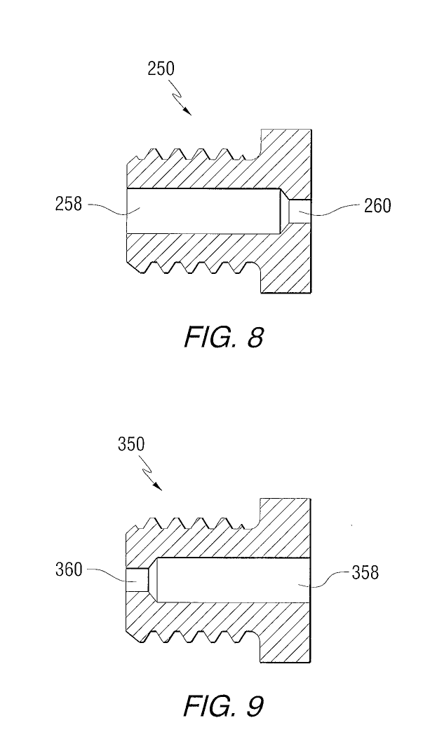

Another embodiment of the present invention having a plug type of coolant nozzle is shown in FIG. 7. A cross-section view along the center line of the coolant duct 140 of the milling cutter 101. The milling cutter 101 has a body 120 with a plurality of recessed cutting portions 110. Each recess 110 has a seating surface 111 for mounting a cutting insert 102. At an end of the coolant duct 140 is a discharge end 144. Between the discharge end 144 and the recess 1 10 is an internally threaded countersunk portion 151. A step 132 radially extends from the coolant duct 140 to the countersunk portion 151. In this embodiment, the coolant nozzle 150 has a threaded portion 154 and a head 152. The threaded portion 154 and the head 152 are both externally threaded and both have the same external diameter. This structure enables the entire coolant nozzle 150 to be threaded into the countersunk portion 151 until the threaded portion abuts the step 132 between the coolant duct 140 and the countersunk portion 151. The bore 158 may be a first tapered portion 153 which provides a smooth transition between the coolant duct 140 and the bore 158 of the coolant nozzle 150. A second tapered portion 155 provides a smooth transition between the bore 158 and the restriction 160. The head 152 of the coolant nozzle 150 has a driver indentation 156 at the discharge end 159. The bore 158 and restriction 160 are dimensioned as described in earlier embodiments.

Coolant nozzles 50, 150 are typically threaded into the coolant ducts 40, 140. Liquid thread locking compound may be applied to the coolant nozzles 50, 150 to ensure the coolant nozzles 50, 150 are securely held in the coolant ducts 40, 140. This facilitates easy installation and removal of the coolant nozzles 50, 150. In this manner, coolant nozzle restriction diameters can be changed on a given milling cutter 1, 101 or the replacement nozzles may be installed. While a threaded connection is preferred, it has been contemplated that a press fit, adhesive or welded connection could be used to retain the coolant nozzles within the coolant ducts.

FIGS. 8 and 9 depict embodiments of the present invention having alternate location of the restriction within the coolant nozzle. FIG. 8 shows a coolant nozzle 250 with the restriction 260 at the discharge end of the coolant nozzle 250 and the bore 258 at the inlet end or the coolant nozzle 250. FIG. 9 shows a coolant nozzle 350 with the restriction 360 at the inlet end of the coolant nozzle 350 and the bore 358 at the discharge end or the coolant nozzle 350.

Whereas particular embodiments of this invention have been described above for purposes of illustration, it will be evident to those skilled in the art that numerous variations of the details of the present invention may be made without departing from the invention as defined in the appended claims.

1. A milling cutter comprising:
a cutter body including a plurality of recessed cutting portions;
a coolant reservoir within the cutter body;
a plurality of coolant ducts extending from the reservoir to the recessed cutting portions each having a reservoir end and a discharge end; and
at least one coolant nozzle inserted into the discharge end of the coolant duct having a restriction having an internal diameter less than an internal diameter of the discharge end of the coolant duct.

2. The milling cutter of claim 1, wherein a coolant nozzle is inserted into the discharge end of each coolant duct.

3. The milling cutter of claim 1, wherein the discharge end of the coolant duct and the coolant nozzle share a central longitudinal axis and wherein the coolant nozzle further comprises a bore along the central longitudinal axis having an internal diameter greater than the internal diameter of the restriction.

4. The milling cutter of claim 3, wherein the coolant nozzle further comprises a tapered portion between the bore of the coolant nozzle and the restriction of the coolant nozzle.

5. The milling cutter of claim 3, further comprising countersunk portions between the discharge end of each coolant duct and each recessed cutting portion.

6. The milling cutter of claim 4, wherein the coolant nozzle has a head and a threaded portion and the head has a larger external diameter than an external diameter of the threaded portion, whereby the head seats within the countersunk portion and wherein the head of the coolant nozzle fits completely with the countersunk portion.

7. The milling cutter of claim 5, wherein the head comprises a driver indentation adapted to receive a slotted, hexagonal, star-shaped or square driver.

8. The milling cutter of claim 1, wherein the restriction has an inside diameter about 0.5 mm to about 2.5 mm.

9. The milling cutter of claim 1, wherein the restriction has an inside diameter of about 1.5 mm.

10. A milling cutter comprising:
a cutter body including a plurality of recessed cutting portions;
a coolant reservoir within the cutter body;
a plurality of coolant ducts extending from the reservoir to the recessed cutting portions each having a reservoir end, discharge end and a countersunk portion; and
a coolant nozzle having a head and a threaded portion.

11. The milling cutter of claim 16, further comprising a step between the discharge end and the countersunk portion, wherein the head of the coolant nozzle has a diameter larger than the threaded portion of the coolant nozzle, wherein the head of the coolant nozzle seats on the step of the coolant duct.

12. The milling cutter of claim 10, wherein the discharge end of the coolant duct and the coolant nozzle share a central longitudinal axis and wherein the coolant nozzle further comprises a bore along the central longitudinal axis having an internal diameter greater than the internal diameter of the restriction.

13. The milling cutter of claim 10, wherein the coolant nozzle is externally threaded and the countersunk portion is internally threaded.

14. The milling cutter of claim 12, wherein the coolant nozzle further comprises a first tapered portion between the coolant duct and the bore of the coolant nozzle and a second tapered portion between the bore of the coolant nozzle and the restriction of the coolant nozzle.

15. A coolant nozzle for use in milling cutter comprising:
an inlet end;
a discharge end;
a bore between inlet end and the discharge end having an inside diameter and providing fluid communication between the inlet end and discharge end;
a driver indentation in fluid communication with the inlet end and discharge end located between the discharge end and the bore having an inside diameter or width greater than the inside diameter of the bore structured and arranged to receive a driving device,
wherein the bore and driver indentation are centered about a longitudinal axis of the nozzle.

16. The coolant nozzle for use in metal cutting tool of claim 15, wherein the driver indentation is configured to receive a slotted, square, rectangular or hexagonal driver.
